(19) United States
(12) Patent Application Publication
(10) Pub. No.: US 2006/0103089 A1
(43) Pub. Date: May 18, 2006

(54) Household lectern

(76) Inventor: John David Decoste, Dartmouth (CA)

Correspondence Address: John David Decoste, 41 Woodland Avenue, Dartmouth, NS, B3A 3J6, CA

(21) Appl. No.: 10/989,442

(22) Filed: Nov. 17, 2004

(51) Int. Cl. B62B 3/00

(52) U.S. Cl. 280/47.34

(57) ABSTRACT

A household lectern to be used in bathrooms. The lectern comprises a sloped top to provide comfortable eye focus on reading material and at an ergonomic height for a person sitting on a toilet. The top panel of said lectern is hinged in the back to open-up to a shelf on the inside for storing reading material. The lectern can also store in its lower cavity as many as 12 double-rolls of toiler paper, additional magazines, toilet accessories and/or products in the storage space accessible from the front. The lectern comprises a toilet paper roll holder on either side of the lectern. Due to the growing concerns today of obese, physically challenged and the elderly people; the household lectern utilizes lockable wheels to help assist people in sitting down and standing up from a seated position.

### CROSS-REFERENCE TO RELATED APPLICATION

Not Applicable

### FEDERALLY SPONSORED RESEARCH

Research Not Applicable

### SEQUENCE LISTING OR PROGRAM

Not Applicable

### BACKGROUND OF INVENTION

The present invention relates to lecterns more particularly to lecterns that are mobile and have multiple functions.

### BRIEF SUMMARY OF THE INVENTION

It has long been conventional practice for the lectern to hold a lecturer's book or reading material, i.e. in classrooms, churches and halls to name just a few.

Lecterns have been used to store reading material under the lid or a lower compartment of the lectern. Lecterns sometimes are portable, collapsible and even sometimes permanent fixtures.

Even though lecterns have been commonly known for these above-mentioned uses they have not been designed or intended for utilization in the bathroom environment, i.e. while sitting on the toilet.

For many generations now it has been customary for people to lay magazines and books uncomfortably on their lap while reading when sitting on the toilet bowl creating a clumsy and awkward condition.

Usually magazines are stored in a separate rack that is more than an arms length away and toilet paper rolls are most often stored under the sink area or in a holder and in an awkward position to reach when sitting on the toilet bowl.

At times the single toilet paper roll that is used while sitting on the toilet bowl is awkward to reach and sometimes requires twisting and straining of the back. Above all there are many people today such as the elderly and the physically challenged that have trouble sitting down and standing up from the toilet bowl with out some sort of assistance.

This invention is called, the household lectern and it has been designed to assist the everyday toilet user. The structure being at approximately knee height will allow the user to sit on the toilet bowl, lay their book, newspaper or magazine on the top portion of the unit that is sloped towards the user ergonomically improving eye focus on material thus reducing eye stress.

The household lectern is comprised of a toilet paper holder at a very natural and ergonomic height and reaching position on the left or right side depending on the user. This will remedy the twisting and straining of the back and prevent falls or injuries. The household lectern will allow books, magazines and newspapers to be stored on a shelf that is located inside the unit which is visible once the top portion of the unit is opened upward which is hinged from the back.

The hollow portion under the shelf will be revealed by two front doors that can be used as storage space for additional magazines, toilet products and/or accessories. The household lectern due to its sturdy construction and locking wheels will aid users in sitting down and standing up.

In whole the household lectern is designed to prevent a user from ever having to leave the toilet bowl unnecessarily, in addition it can also be used to assist users when sitting down or standing up from toilet.

### BRIEF DESCRIPTION OF THE SEVERAL VIEWS OF DRAWINGS

FIG. 1 shows a front view of The Household Lectern.

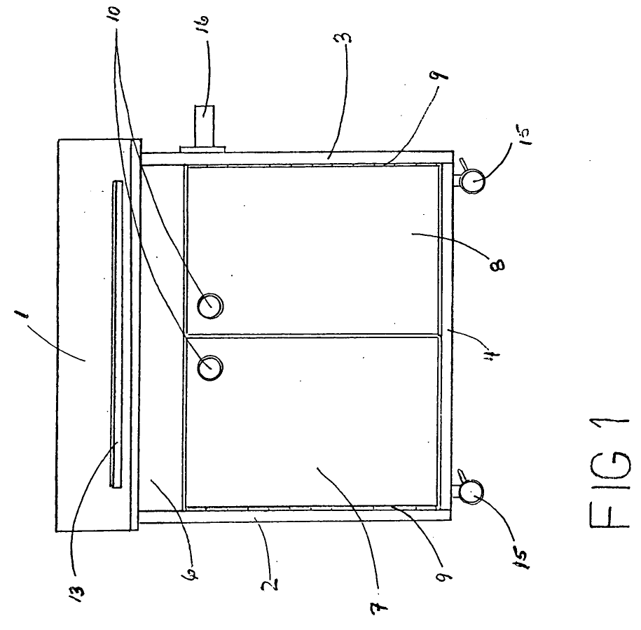

FIG. 2 shows a left view of The Household Lectern.

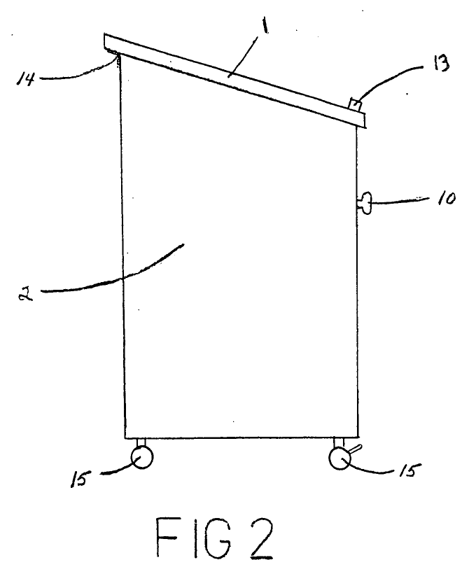

FIG. 3 shows a right side view of The Household Lectern.

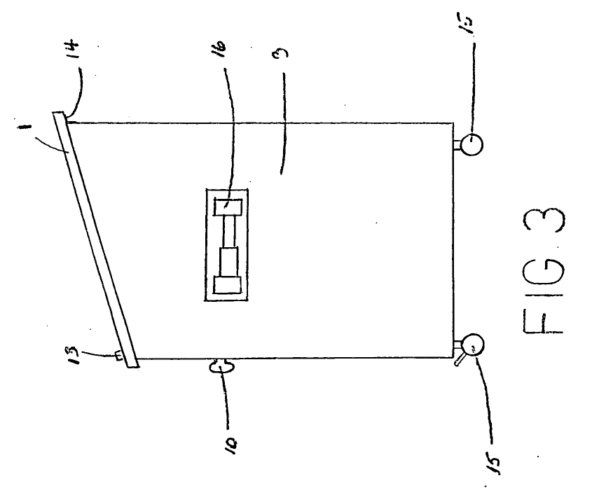

FIG. 4 shows a bottom view of The Household Lectern.

FIG. 5 shows a rear view of The Household Lectern.

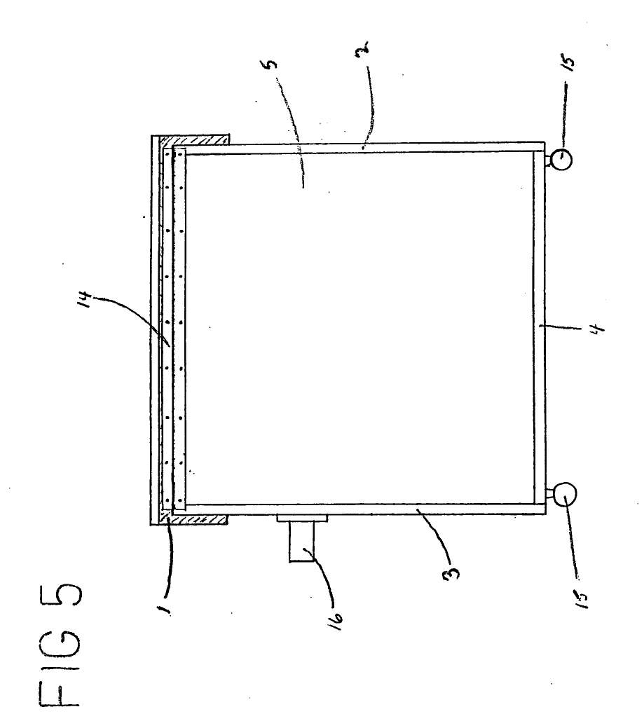

FIG. 6 shows a front view of The Household Lectern with front doors open.

FIG. 7 shows a transparent view of The Household Lectern depicting the location of the inner shelf.

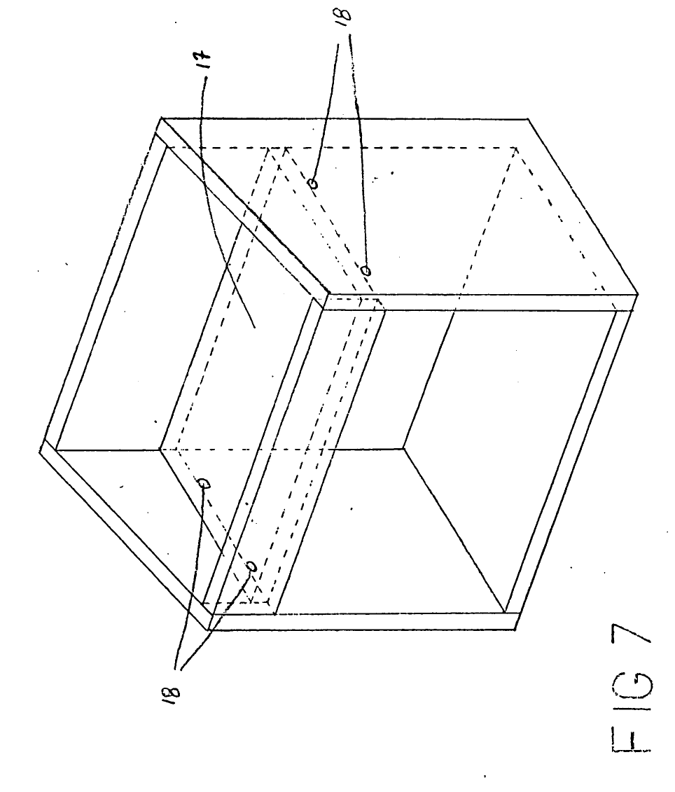

FIG. 8 shows a front view of The Household Lectern displaying the top open.

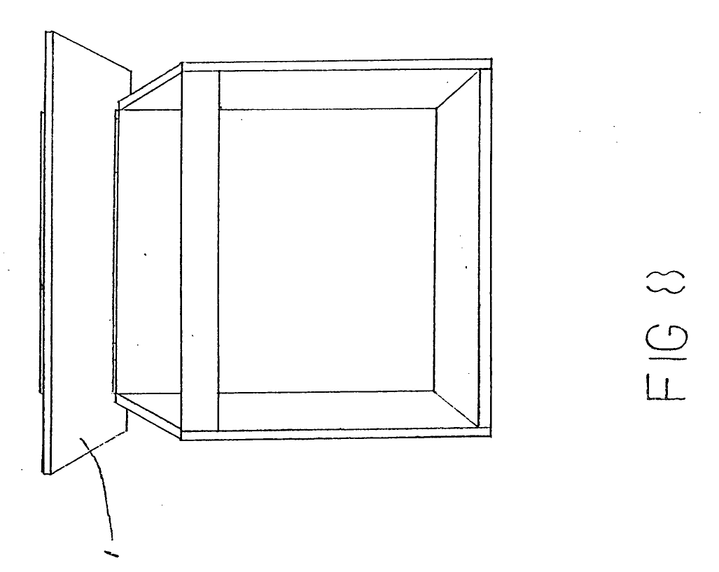

FIG. 9 shows a view of inner shelf of The Household Lectern displaying location of door magnet

### DETAILED DESCRIPTION OF THE INVENTION

The bottom panel 4 is attached perpendicularly to the bottom of the three vertical walls 2, 3 and 5. The two said sidewalls 2 and 3 being taller in the back as opposed to the front will form the sloped top from back to front of the ever-popular design of a lectern.

The front panel 6 is perpendicularly attached to the top front portion of the two said side panels 2 and 3 to sturdy the embodiment of the lectern hence forming a box like structure.

By laying and centering the top panel 1 down on top of said box structure, said top panel 1 is attached to the top portion of said back panel 5 together with a hinge 14 to facilitate the opening from above to reveal the hollow inners of the lectern. Said top panel 1 will be sloped from back to front when installed, The said top panel 1 is hinged from the back but may be hinged from either said side panel 2 or said side panel 3 to open up like a book if builder sees fit, also the embodiment uses a piano type hinge hence a smoother swing and greater security is added, but conventional type hinges may also be employed.

A thin strip of material 13 be what it may depending on choice of material for the structure of said lectern is attached to the top but on the low end of the slope of said top panel 1 to prevent reading material from sliding off said lectern.

The left door 7 being fastened perpendicularly to the front of said side panel 2 with a hinge 9 will facilitate in opening of door. The embodiment uses piano type hinge, hence a smoother swing and greater security is added, but conventional type hinges may also be employed.

The right side door 8 being fastened perpendicularly to the front of said side panel 3 with a hinge 9 will facilitate in opening of door. The embodiment uses piano type hinge, hence a smoother swing and greater security is added, but conventional type hinges may also be employed.

Door handle 10 is fastened to the top right corner of said left door 7 and to the top left corner of said right door 8 to aid in opening and closing of said doors 7 and 8.

A plurality of shelf holder pins 18 are placed in pre-determined holes, positioned on the right side so to be on the inside of said lectern of said side panel 2 and on the left side so to be on the inside of said lectern of said side panel 3. Said shelf holder pins 18 are to support the shelf 17 placed down from the top opening of the lectern when said top panel 1 is opened up. Said shelf 17 is the supporting member for such items as magazines, books, newspapers and toilet products and/or accessories. Shelf holder pins were used in this embodiment but conventional type shelf holders may also be employed.

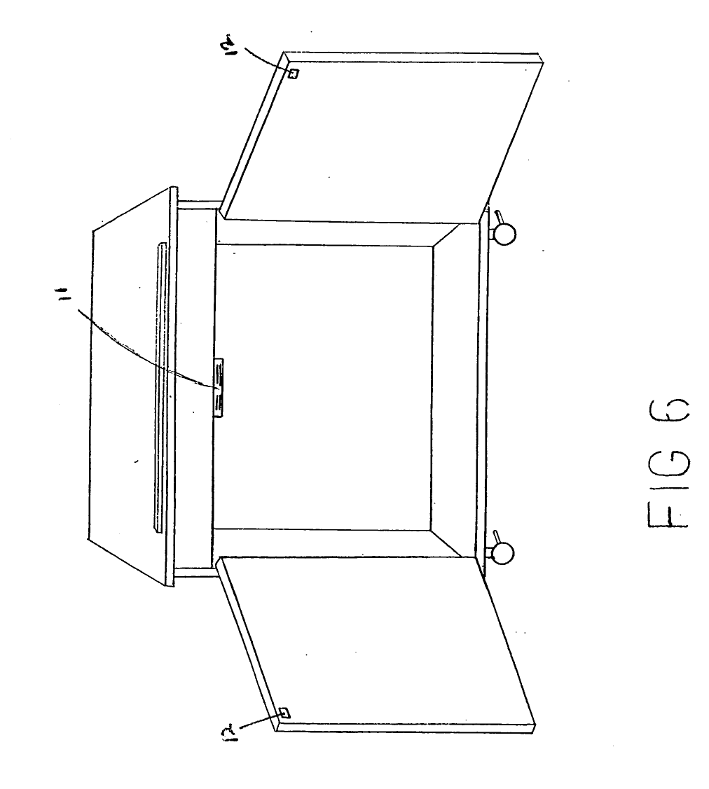

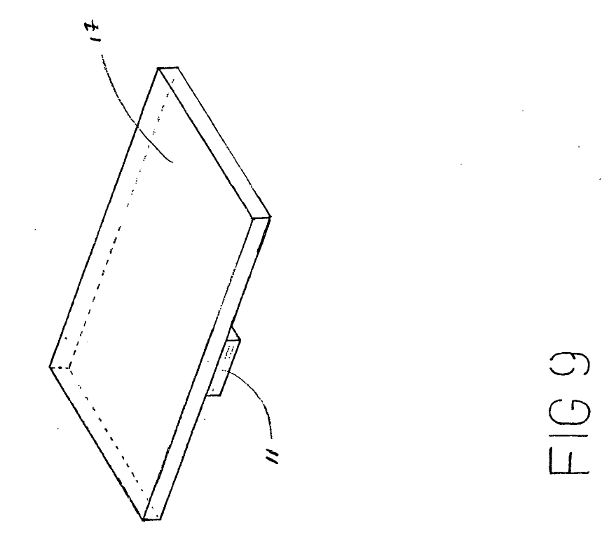

A door magnet 11 is attached to the under side and in the front of said inner shelf 17 as depicted in FIG. 6 and FIG. 9 when aligned with metal devices 12 placed on the inside of said doors 7 and 8 depicted in FIG. 6 will assist in holding said front doors closed due to magnetism. Magnetic strips and magnets were used in this embodiment but any conventional means for holding a door closed may be used.

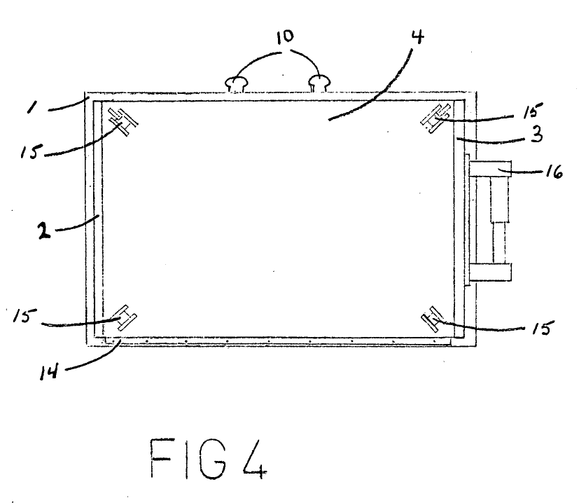

Four casters in which 2 consist of locking devices 15 are attached to each corner with a plurality of fasteners of the underside of said bottom panel 4 as depicted in FIG. 4 for easy movement of lectern. Sturdy casters were used in this embodiment for strength and durability but any type of wheel could be employed.

Finally, a toilet paper dispensing assembly 16 is provided. Such dispensing assembly is attached with a plurality of fasteners to either said side panel 2, left side or said side panel 3, right side. Placing the toilet paper holder on either left or right side will depend on the user. The embodiment of said lectern uses a conventional toilet paper holder as described above but any device of toilet paper holder could be employed.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for reading while sitting on a toilet by using a lectern built to an appropriate height.

2. A household lectern comprising,
a bottom panel, upright side walls and a rear wall attached to and extending upwards from said bottom panel, and a front panel attached perpendicularly to the top front of said side walls just big enough to form a box like cavity but leaving an opening in the front and an opening downward from the top thereof, and
a top panel pivotally attached to said rear wall and movable between an open position, in which said cavity is accessible from a position downward thereof, and a closed position, in which said top panel contacts said side walls, rear wall and front panel preventing access to said cavity from a position downward thereof, and
said top panel will be sloped downward from back to front due to said sidewalls being constructed taller in the back then in the front to form the ever popular design of said lectern, and
a lower edge of said top panel is provided with stop means to prevent magazines placed on said top panel from sliding off, and
a shelf is placed downward thereof from said top opening when said top panel is opened up, laying on a plurality of shelf holders attached to said side walls placing said shelf perpendicularly flush with the lowest end of said front panel, and laying perpendicular to said side walls and said back wall but not attached to said side walls and said back wall, separating said inner cavity into two separate cavities, top cavity being revealed downward from top when said top panel is open upward and lower cavity under said shelf being exposed by opening in front of said lectern, and
a door pivotally attached to each said side wall moveable between an open position, in which said lower cavity is accessible from a position forward thereof and a closing position, in which prevents access to said lower cavity from a position forward thereof, and
a device for holding said doors closed, and
casters attached to the underside of said lectern with a plurality of fasteners to ensure mobility of said lectern.

3. A household lectern as set forth in claim 2 in which a toilet paper holder is attached with a plurality of fasteners to either said sidewall.

4. A household lectern as set forth in claim 2 to aid an individual in standing up or sitting down comprising,
lockable casters attached to the underside of said lectern with a plurality of fasteners to ensure mobility and said lockable casters preventing involuntary movement of said lectern.

5. A household lectern as set forth in claim 3 to aid an individual in standing up or sitting down comprising,
lockable casters attached to the underside of said lectern with a plurality of fasteners to ensure mobility and said lockable casters preventing involuntary movement of said lectern.
